(19) United States
(12) Patent Application Publication
(10) Pub. No.: US 2010/0313237 A1
(43) Pub. Date: Dec. 9, 2010

(54) Method and Device for Receiving and Transmitting a Signal Being Transmitted in the Time Slicing Mode in the form of a Plurality of Bursts

(75) Inventors: Pieter Pieter van Gassel, Eindhoven (NL); Fangzhong Shen, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/679,495

(22) PCT Filed: Sep. 17, 2008
(86) PCT No.: PCT/IB2008/053766

§ 371 Date: Jul. 12, 2010

(30) Foreign Application Priority Data
Sep. 29, 2007 (CN) 200710153237.3

(51) Int. Cl. H04N 7/16

(52) U.S. Cl. 725/146; 725/62

(57) ABSTRACT

A method and device of transmitting and receiving a signal corresponding to a service from among a plurality of services, said signal being transmitted in the time slicing mode in the form of a plurality of bursts, the transmission method comprising the steps of storing a time table in each given burst to be transmitted among said plurality of bursts, said time table including a set of duration values from the start of said given burst to the start of its following successive bursts corresponding to said plurality of services and a set of packet identifiers (PID) linking said following successive bursts to said set of duration values, and the method of receiving said signal by a receiver, which receiver may be switched off during non-selected services being transmitted in the zapping mode by obtaining the start time of the selected service from the transmitted time table stored in each burst corresponding to each service. By this method, the power consumption of the receiver can be saved in the zapping mode.

### FIELD OF THE INVENTION

The present invention relates to a digital broadcasting system. More specifically, the invention provides methods and devices for transmitting and receiving data in a digital broadcasting system.

### BACKGROUND OF THE INVENTION

The DVB-H standard (Digital Video Broadcasting-Handheld) is based on the existing digital terrestrial broadcasting standard DVB-T (Digital Video Broadcasting-Terrestrial). It is supposed to be used in handheld devices such as mobile phones.

The DVB-H standard performs time division multiplexing per service (i.e. per channel). Due to this time division, the average transmission rate for each service is small while current transmission rates may be high. Respective services that have been coded according to this time division are referred to as time slices or bursts.

Respective DVB-H services are transmitted in the form of bursts, and respective bursts represent groups of a plurality of services, and are of predetermined burst length. Different services are similarly transmitted via bursts at other time periods. This telecommunication system comprises a receiver for receiving data of services. The receiver is switched on only when the burst carrying the selected service is transmitted.

In between the bursts of a service selected by the user, the receiver is switched off and the received (buffered) burst is delivered. Powering off between bursts saves considerable amounts of power in mobile devices. In order to know the arriving time of a following burst of the selected service, a delta-t method is recommended by the DVB-H standard.

However, if the user wants to switch to a different service (i.e. switch to another program/channel) from the currently received burst, the receiver does not know the arriving time of other bursts. Thus, the receiver has to maintain its switched on state till the expected bursts come. This increases the power consumption when switching from one service to another (i.e. “zapping mode”).

### SUMMARY OF THE INVENTION

It is an object of this invention to provide in a communication system a receiving method for receiving by a receiver a signal corresponding to a service selected from a plurality of services, the signal being transmitted in the time slicing mode in the form of a plurality of bursts.

To this end, the method comprises the steps of:
receiving a first burst corresponding to a first selected service, wherein a first time table is stored in said first burst for signaling a set of duration values from the start of said first burst to the start of its following successive bursts corresponding to said plurality of services;
powering off said receiver after receiving said first burst;
comparing a first start time of a second burst corresponding to a second selected service with a request time when a request to switch from said first selected service to said second selected service is received by said receiver, said first start time being derived from said first time table;
if said request time is earlier than said first start time, powering on said receiver according to said first start time;
if said request time (tq) is later than said first start time, obtaining a second start time of a third burst corresponding to said second selected service, said third burst following said second burst, and then powering on said receiver according to said second start time.

It is also an object of the invention to provide in a communication system a transmission method for the transmission of a signal by a transmitter, corresponding to a service selected from a plurality of services, said signal being transmitted in a time slicing mode in the form of a plurality of bursts.

To this end, the method comprises the steps of storing a time table in a given burst to be transmitted among said plurality of bursts, said time table including a set of duration values from the start of said given burst to the start of its following successive bursts corresponding to said plurality of services, and a set of packet identifiers (PID) linking said following successive bursts to said set of duration values.

It is also an object of the invention to provide a receiver for receiving a signal corresponding to a service in a communication system.

It is also an object of the invention to provide a transmitter for transmitting a signal corresponding to a service in a communication system.

By the proposed method and device, the power of the receiver is saved not only in the common watching mode but also in the zapping mode.

### BRIEF DESCRIPTION OF THE DRAWINGS

FIG. 1 depicts the method flow chart of receiving a signal according to the invention;

FIG. 2 depicts an example of a plurality of bursts corresponding to a plurality of services according to the invention;

FIG. 3 depicts an example of a set of duration values within one burst cycle embedded in burst a1 according to the invention;

FIG. 4 depicts the method flow chart of obtaining a second start time according to the invention;

FIG. 5 depicts an example of a set of duration values within one burst cycle embedded in burst m1 according to the invention;

FIG. 6 depicts a set of duration values within two burst cycles according to the invention;

FIG. 7 depicts the structure of an MPE-FEC frame;

FIG. 8 depicts a block diagram of a receiver according to the invention.

### DETAILED DESCRIPTION OF THE INVENTION

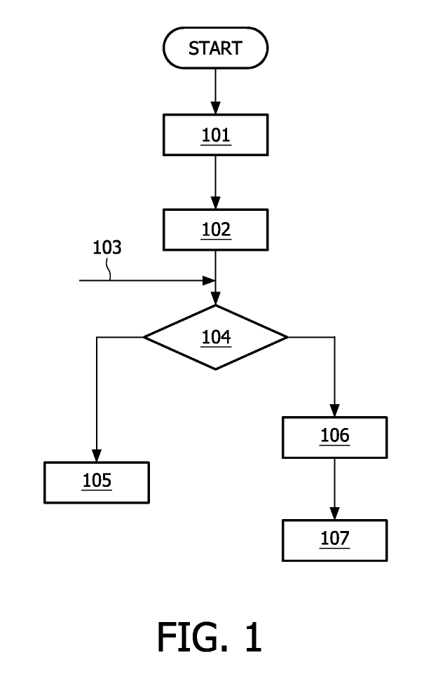

FIG. 1 depicts the flow chart of a receiving method for receiving a signal by a receiver, corresponding to a service selected from a plurality of services, the signal being transmitted in the time slicing mode in the form of a plurality of bursts

The method comprises the steps of:

receiving 101 a first burst a1 corresponding to a first selected service A, a first time table tt1 being stored in the first burst a1, the first time table being designed for signaling a set of duration values from the start of said first burst a1 to the start of its following successive bursts corresponding to said plurality of services;

powering off 102 said receiver after receiving the first burst a1;

comparing 104 a first start time Sk1 of a second burst k corresponding to a second selected service K with a request time tq when a request to switch 103 from the first selected service A to the second selected service K is received by the receiver, the first start time Sk1 being derived from the first time table tt1;

if the request time tq is earlier than the first start time Sk1, powering on 105 the receiver according to the first start time Sk1;
if said request time tq is later than said first start time Sk1, obtaining 106 a second start time Sk2 of a third burst k2 corresponding to the second selected service K, the third burst k2 following the second burst k1, and then powering on 107 the receiver according to the second start time Sk2.

The signal, for example in a broadcasting system, carries the data related to the service (such as: TV program). The signal is transmitted and received in the DVB-H standard or any other standard that uses the time slicing mode. A receiver can be, for example, a PDA (Personal digital assistant) or a mobile phone with a TV function.

Step 101 is used for receiving a first burst a1 corresponding to a first selected service A. The first burst a1 is stored with a first time table tt1 signaling a set of duration values from the start of the first burst a1 to the start of its following successive bursts corresponding to a plurality of services.

After receiving burst a1, step 102 of powering-off the receiver follows. As indicated in the background section, in the time slicing mode, the receiver is switched on only when the burst carrying the selected service is transmitted for power saving. Between the bursts of selected service the receiver is switched off and the received (buffered) burst is delivered.

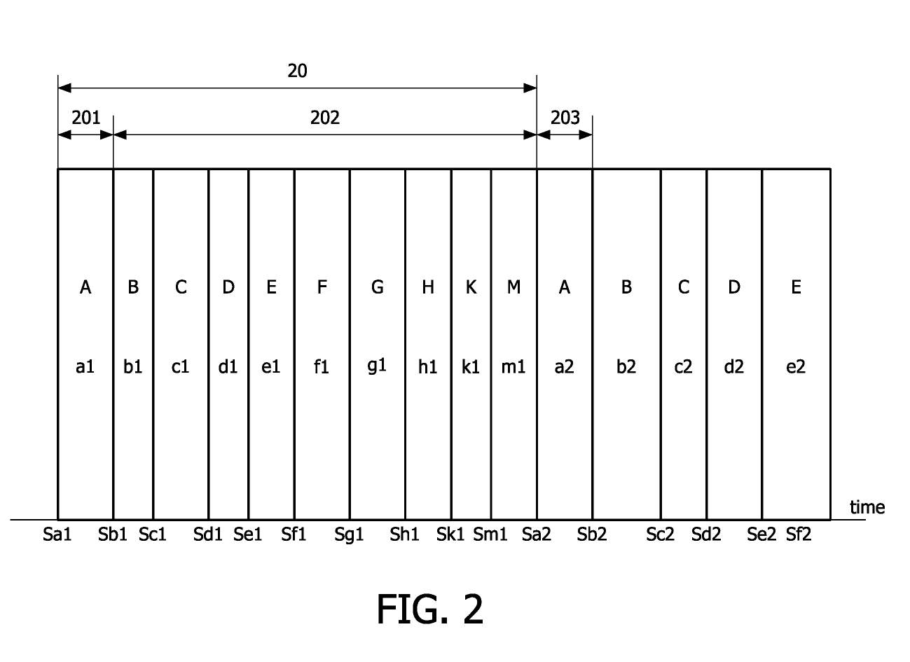

FIG. 2 depicts an example of a plurality of bursts corresponding to a plurality of services:
burst a1 and burst a2 are related to service A;
burst b1 and burst b2 are related to service B;
burst a1 is transmitted from time Sa1 to Sb1;
Sa1 is the start time of burst a1 being transmitted.
Sb1 is the end time of burst a1 being transmitted and also is the start time of burst b1 being transmitted after burst a1.

A similar definition could be given for services C, D, E, F, G, H, K, and M.

When the user wants to watch service A, he selects service A (e.g. via remote control). The receiver is switched on during period 201 (from Sa1 to Sb1) and period 203 (from Sa2 to Sb2) for receiving burst a1 and a2 corresponding to service A.

And between 201 and 203, the receiver is switched off during period 202 (from Sb1 to Sa2) to save power.

Before the receiver is able to receive bursts a1 and a2, a preparation time is needed after it was switched on, hence, the receiver is switched on just before the start time of a burst to be received according to the preparation time. The preparation time is different for a different broadcasting system.

In the following, statement “powering-on the receiver according to the start time of a burst” means that the receiver is switched on before a preparation time of the start time of a burst.

In order to determine when the receiver should be switched on again for receiving a following burst corresponding to the same service selected by the user, as indicated in the background section, a delta-t method is recommended by the DVB-H standard. A delta-t value embedded in a burst intends to inform the time from the start of this burst to its following burst within a same elementary stream. A same elementary stream refers to a same service (program). In order to keep the delta-t information insensitive to any constant delays on the transmission path, delta-t information is relative information (e.g. “following burst starts 5500 ms from the present time”).

Delivering delta-t information in bursts removes the need to synchronize clocks between transmitter and receiver. High flexibility is supported since parameters such as: burst size, burst duration, burst bandwidth and off-time may freely vary between elementary streams as well as between bursts within an elementary stream. The receiver has to support sufficient accuracy for one off-time only, as the clock is restarted by each burst.

For example, in FIG. 2, by receiving burst a1, the receiver obtains a delta-t_a1 20, which indicates the duration from the start time of burst a1 to the start time of burst a2.

Usually, according to delta-t information, the receiver knows when the following burst corresponding to a same service will arrive, so the receiver will remain switched off until the following burst comes for power saving.

However, when the user does not want to watch the selected service, the user gives a switch request 103, (for example: from service A to service K) at time tq, a comparing step 104 is performed to compare the start time Sk1 of burst k1 with the request time tq, the start time Sk1 being derived from a time table tt1 stored in burst a1. Details of the time table are described below.

For example, in FIG. 2 the status of receiver is switched off at time tq, in order to switch the service from service A to service K, the receiver needs to receive the data of burst k1 corresponding to service K. If the receiver knows the start time Sk1 of burst k1, it can remain switched off till the start time Sk1. Otherwise it is switched on at time tq to wait for the data of burst k1.

In order to inform the start time of other bursts, this invention proposes a time table stored in each burst. Each time table in each burst is used for signaling a set of duration values from the start of this burst stored with the time table to its following successive bursts. From the information of these duration values from a burst, the receiver is able to determine the start time of the other burst corresponding to the other service.

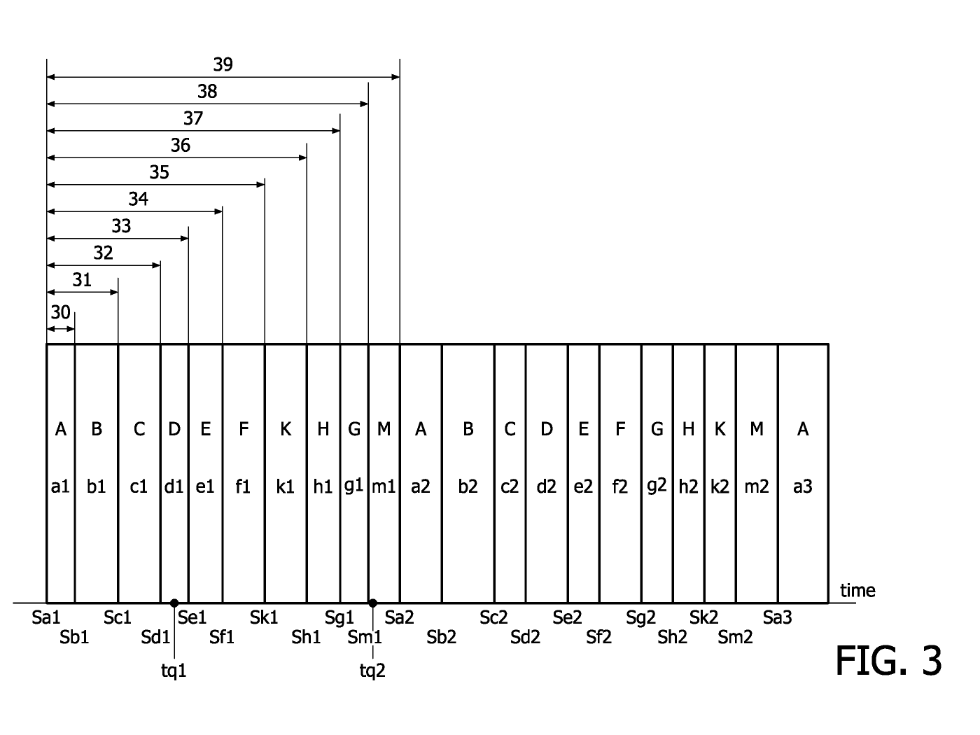

FIG. 3 is an example of successive duration values included in a time table. For example, a set of duration values is represented by reference number 30, 31, 32 . . . 39.
30 is the duration value from the start time Sa1 of burst a1 to the start time Sb1 of the following burst b1 corresponding to service B;
31 is the duration value from the start time of burst a1 to the start time Sc1 of burst c1 corresponding to service C;
32 is the duration value from the start time of burst a1 to the start time Sd1 of burst d1 corresponding to service D, and so on.

For example, if the duration value 31 is 5 ms, this means that burst c1 will start to be transmitted 5 ms later than the start time of burst a1.

From this set of duration values, the receiver can know the start time of the following other bursts corresponding to other services. Thus, the receiver need not be switched on immediately to wait for the following other burst corresponding to the other service when it receives a switch request to switch to the other service. In this way, the power can also be saved even if the receiver is in the zapping mode.

In the following, the description refers to table 1 and table 2, which are two examples of time tables to be stored in the given bursts.

Table 1 below is an example of a time table including a first column representing the duration value, the other column representing PID (packet identifier) information for linking the duration values to the bursts (and, in consequence, to the services).

For example, if table 1 is derived from burst a1, the duration value in table 1 means the duration from burst a1 to its following burst b1, c1, d1 . . . m1, a2. When the receiver needs to know the start time of burst k1, identified by PID information included in table 1, the receiver can get the duration value of 35 as the duration from the start time of burst a1 to the start time of burst k1, then based on the time of a1 being received, the receiver knows the exact start time Sk1 of burst k1 to be received.

TABLE 1

| PID | Duration value (ms) |
|---|---|
| B | 30 = xxxx |
| C | 31 = xxxx |
| D | 32 = xxxx |
| E | 33 = xxxx |
| F | 34 = xxxx |
| K | 35 = xxxx |
| H | 36 = xxxx |
| G | 37 = xxxx |
| M | 38 = xxxx |
| A | 39 = xxxx |

As shown in FIG3, at the comparison step 104, the receiver first gets a start time Sk1 of burst k1 according to the duration value 35 from a time table (for example: table 1) stored in burst a1. Then, the receiver performs the comparing step 104 to decide whether the start time of nearest burst k1 corresponding to service K has passed or not.

And then, depending on the result of comparing step 104, if the request time tq is earlier than the start time Sk1, for example, in FIG. 3, tq1 is earlier than Sk1. This means that the start time of burst k1 is not past time tq1, so that the receiver can remain switched off till the start time Sk1 arrives. The receiver is switched on according to the start time Sk1 for receiving the data of burst k1.

As discussed above, the exact time of powering-on is the start time Sk1 minus a preparation time, and for the same reason, at the comparing step 104, the compared time Sk1 should also be the start time of a burst minus a preparation time. It is to be understood by the skilled person in the art that the description in this invention is just for explaining the principle of the invention, and cannot be regarded as limiting the invention.

On the contrary, according to the result of comparing step 104, if the request time tq is later than the start time Sk1 of burst k1, for example in FIG. 3, tq2 is later than Sk1, this means that the start time for receiving burst k1 has already passed. In this situation, an obtaining step 106 is further needed to obtain the following burst k2 corresponding to service K at start time Sk2. Burst k2 is the closest burst following burst k1. After obtaining a new start time Sk2, the receiver is then switched on according to the start time Sk2.

According to one embodiment of this invention, the burst and its following successive bursts defined in the time table are within one burst cycle. In this time table the duration values from the start time of a burst to the start time of its following burst will be indicated only once per service. For example in FIG. 3 and table 1, because the total service number is 10, there are 10 duration values in the time table. Each duration value represents a duration value from the start time of burst a1 to the start time of another burst following burst a1 between burst a1 and burst a2. The 10^{th} duration value is the same as the original delta-t value.

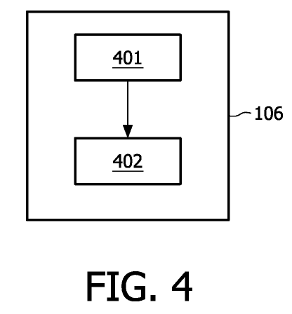

FIG. 4 depicts the flow chart of an obtaining step. If the time table only includes the duration value within one burst cycle and the first start time Sk1 is earlier than the request time tq, the obtaining step 106 further comprises the steps of: powering on 401 the receiver for receiving a currently transmitted burst corresponding to one of said plurality of services after the comparing step 104 has been performed. For example in FIG. 3, when the user gives a switch request at time tq2, which is later than Sk1, and at time tq2 the system is transmitting burst m1 corresponding to service M, the receiver is switched on to receive burst m1.

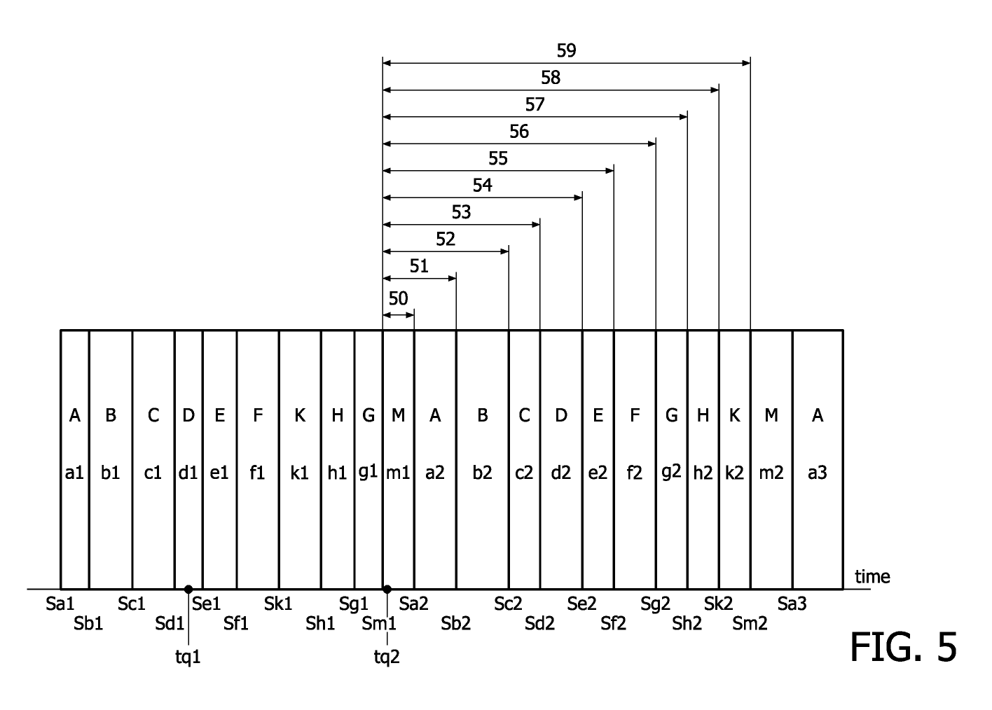

As illustrated above, each burst includes a time table. FIG. 5 illustrates a set of duration values embedded in burst m1, from the time table stored in burst m1, a duration value 58 from the start time 5 ml of burst m1 to the start time Sk2 of burst k2 can be obtained, and, therefore, the start time Sk2 of burst k2 will be known.

After burst m1 has been received, a step of power off step 402 for the receiver is performed to save power. As shown in FIG. 5, burst m1 is transmitted during time 5 ml to Sa2. Therefore, the receiver is switched off at time Sa2.

And then a step of powering on 107 the receiver for receiving the third burst k2 is performed according to the second start time Sk2.

According to another embodiment of this invention, the duration values from the burst to its following successive bursts are within two burst cycles.

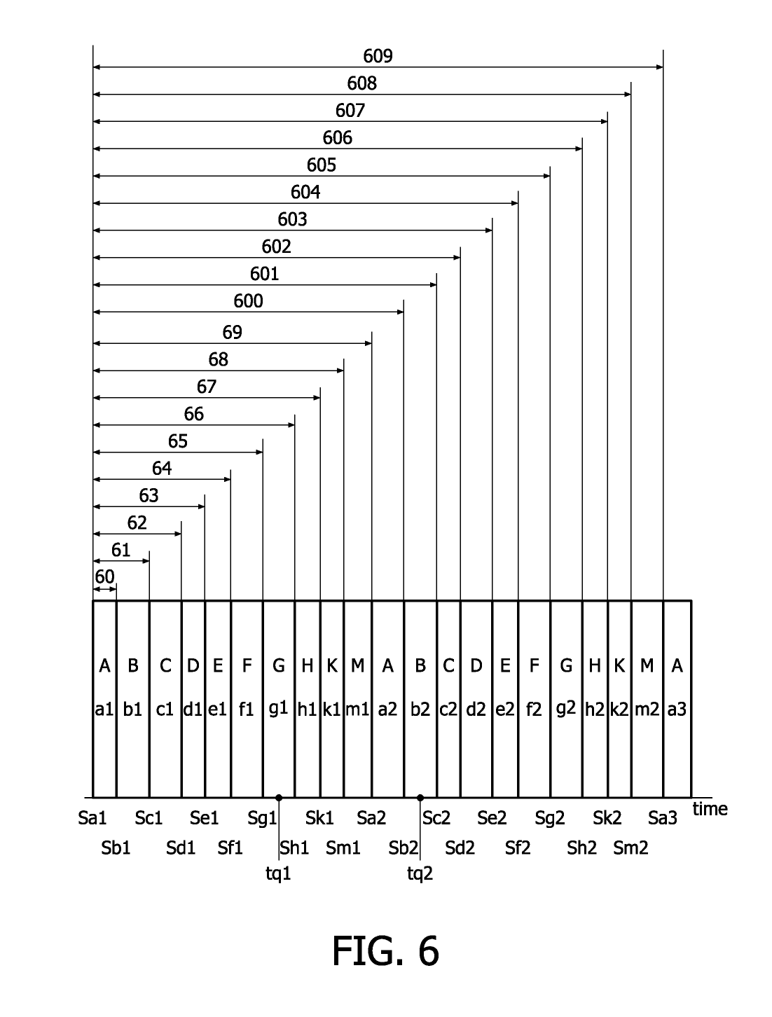

FIG. 6 depicts a set of successive bursts with two cycle duration values. Table 2 shows an example of a time table including two cycle duration values. As shown in table 2, the time table includes the duration value within two burst cycles. The duration values from the start time of burst a1 to the start time of following bursts will be indicated twice per service. For example, in table 2 and FIG. 6, the total service number is 10, and so the time table includes 20 duration values.

According to the time table two burst cycles are involved if the request time tq is later than the start time Sk1 of first burst k1. In the obtaining step 106 a second start time Sk2 can be obtained directly from the time table stored in burst a1. This time table is also used for obtaining the first start time Sk1. And then the receiver is switched on 107 at time Sk2 to receive burst k2 to be delivered.

For example, in table 2, duration 607 is the duration value from the start of burst a1 to the start of burst k2. The start time Sk2 of burst k2 can therefore be obtained. So the receiver can remain switched off till the start time Sk2 comes.

TABLE 2

| PID | Duration value (ms) |
|---|---|
| B (b1) | 60 = xxxx |
| C (c1) | 61 = xxxx |
| D (d1) | 62 = xxxx |
| E (e1) | 63 = xxxx |
| F (f1) | 64 = xxxx |
| K (k1) | 65 = xxxx |
| H (h1) | 66 = xxxx |
| G (g1) | 67 = xxxx |
| M (m1) | 68 = xxxx |
| A (a2) | 69 = xxxx |
| B (b2) | 600 = xxxx |
| C (c2) | 601 = xxxx |
| D (d2) | 602 = xxxx |
| E (e2) | 603 = xxxx |
| F (f2) | 604 = xxxx |
| G (g2) | 605 = xxxx |
| H (h2) | 606 = xxxx |
| K (k2) | 607 = xxxx |
| M (m2) | 608 = xxxx |
| A (a3) | 609 = xxxx |

This invention also proposes a transmission method for the transmission of a signal by a transmitter, corresponding to a service selected from a plurality of services, said signal being transmitted in a time slicing mode in the form of a plurality of bursts. The method comprises a step of storing a time table in each given burst among a plurality of bursts, the time table including a set of duration values from the start of the given burst to the start of its following successive bursts corresponding to the plurality of services and a set of packet identifiers (PID) linking said following successive bursts to the set of duration values.

According to another aspect of this invention, the time table is stored in the padding area of the application data table of the given burst. The padding area corresponds to the area without data.

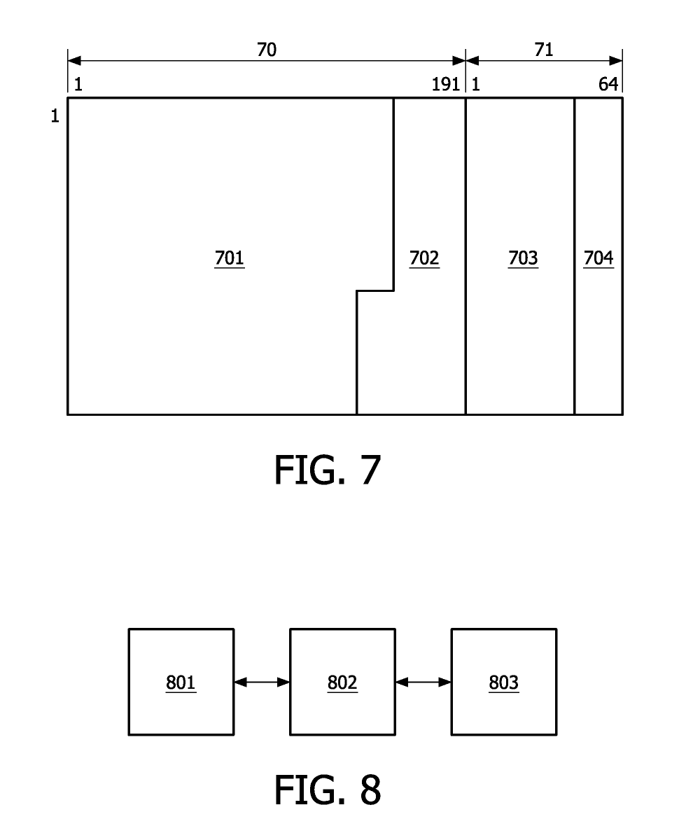

FIG. 7 depicts a structure of an MPE-FEC frame. In the time slicing mode, data in each burst is transmitted in the form of multi-protocol encapsulation (MPE) sections and front forward error correction (FEC) sections. Each MPE-FEC frame is divided into an application data table and an RS data table. The application data table is divided into many MPE sections; the RS data table is divided into many FEC sections. Usually, the application data table includes IP (Internet Protocol) datagrams, and the remaining space of the application data table filled with paddings is called padding area. The padding area means non useful data area. In this embodiment, the padding area is suggested to be used for storing the time table.

For example, in FIG. 7, 701 refers to MPE sections in IP datagrams, 702 is the padding area, 703 are FEC sections with RS data, and 704 is the punctured RS data columns. Because the padding area 703 does not contain useful data, it can be used for storing the time table. In order to signal the receiver from where the time table is stored, an indication header should be added before the time table.

Suppose the maximum number of services is 40 (a typical number of services would be around 16), and each “duration value” needs 12 bits to be represented. Furthermore, the “PID” information needs another 13 bits to be carried. Hence 1000 bits (1000 bits=40*(12 bits+13 bits)) in all are needed per table. Compared to one burst size, which is a maximum of 2 Megabits, the overall overhead is 1000/2000000=0.5%. Since most DVB-H transport streams contain a lot of stuffing data or NULL-packets in practice, the additional time table does not effectively reduce the bandwidth of the system.

According to another aspect of this invention, the time table is stored in a descriptor of PSI/SI (program specific information/system information) information, the PSI/SI information will be signaled periodically. The time table can be stored in a (new) DVB descriptor, which can be added to a section in the data stream at a suitable repetition rate. Preferably it is added to the elementary stream with the same PID as the selected service (in order to reduce the number of required PID filters in the receiver) interleaved with the IP datagram sections. In order to prevent having to repeat this information for every burst, a further optimization could be to assign a special “well-known” PID to this information, which “well-known” PID will be combined with other PSI/SI information that needs to be monitored anyway.

According to another aspect of this invention, the set of duration values in the time table is stored by replacing the original delta-t value separately in successive MPE section headers of a given burst. As described above, the delta-t value signaling the duration from the start of said given burst to the start of the following burst corresponds to a same service from said plurality of services. And the delta-t value is stored in both MPE section header and FEC section header. They are generally called MPE-FEC sections.

Table 3 is the delta-t syntax in the MPE section header. From table 3 it can be seen that delta-t is represented by 12 bits with a resolution of 10 ms. For example: delta-t value 0xC00=3072 indicates the time to the following burst is 30.72 s.

TABLE 3

| Syntax | Number of bits | Identifier |
|---|---|---|
| real_time_parameters ( ) { | | |
| delta_t | 12 | uimsbf |
| table_boundary | 1 | bslbf |
| frame_boundary | 1 | bslbf |
| address | 18 | uimsbf |
| } | | |

In this embodiment, the set of duration values is stored in the current delta-t place, which is located in each MPE section header or FEC section header. The delta-t information is quite redundant already in the current delta-t method recommended by the DVB-H standard, because one burst (time slice) can have a total of 255 sections, each of which will carry the delta-t information. In other words, the delta-t information will be transmitted 255 times repeatedly for one burst (time slice).

Assuming there are n (n=40) services (elementary stream) in total in the transmitting stream (TS), the first 215 (255−n) section headers would be able to deliver the original delta-t information, whilst the rest of 40 MPE section headers are allowed to carry 40 duration values. An indication header is needed before the location of the first duration value to indicate from where the original delta-t value is replaced.

Also the original delta-t information can be delivered by the first 135(215−2n) or 95(215−3n) section headers, thus the rest of 80 or 120 MPE section headers can carry 40 duration values twice or three times to make sure these duration values will not be lost. It will be understood by the skilled person in the art how many MPE sections will be used to carry the duration values for different situations.

According to another aspect of this invention, if a set of duration values is stored in the current delta-t place, then the related set of PID information in the time table has two ways of being stored.

The first way is to store the related PID information in the reserved bits of FEC section headers.

Table 4 below showing the definition of the FEC section header according to the DVB-H standard, there are some reserved bits in the FEC section header. In total 17 reserved bits for future use (see table 4) can be used for storing the information of PID (13 bits). With some indication header, the PID information can be linked to each duration value. In such a way, there will be no overhead at all for storing a time table.

TABLE 4

| Syntax | Number of bits | Identifier |
|---|---|---|
| MPE-FEC_section ( ) { | | |
| table_id | 8 | uimsbf |
| section_syntax_indicator | 1 | bslbf |
| private_indicator | 1 | bslbf |
| reserved | 2 | bslbf |
| section_length | 12 | uimsbf |
| padding_columns | 8 | uimsbf |
| reserved_for_future_use | 8 | bslbf |
| reserved | 2 | bslbf |
| reserved_for_future_use | 5 | bslbf |
| current_next_indicator | 1 | bslbf |
| section_number | 8 | uimsbf |
| last_section_number | 8 | uimsbf |
| real_time_parameters( ) | | |
| for( i=0; i<N; i++ ) { | | |
| rs_data_byte | 8 | uimsbf |
| } | | |
| CRC_32 | 32 | uimsbf |
| } | | |

The second way of storing the related PID information is to store it in a descriptor of PSI/SI information.

In some cases, if no FEC (no RS data carriage) is used, then the related 13 bits PID information can be stored to some descriptor in the PSI/SI information. As described above, PSI/SI information is signaled periodically.

Also, in order to reduce the size of the time table, the duration values and PID information can be compressed with a look up table mapping.

According to another aspect of this invention, when storing the time table in a burst, this burst and its following successive bursts form one burst cycle. In order to know the start time of all the other bursts, the transmitter is adapted for storing the duration values for a whole burst cycle. For example, table 1 is a time table having duration values for one cycle burst.

According to another aspect of this invention, when storing a time table in a burst, this burst and its following successive bursts form two continuous burst cycles. For example, table 2 is a time table having duration values for two cycle bursts.

This invention also proposes a receiver for receiving a signal corresponding to a service selected from a plurality of services, said signal being transmitted in the time slicing mode in the form of a plurality of bursts, the receiver comprising: a receiving unit for receiving the data; a power controller for controlling the receiver to be switched on or switched off; a comparing unit for comparing a start time of bursts with a switch request time.

FIG. 8 is the block diagram showing the functional modules of a receiver according to the invention. It comprises a receiving unit 801 for receiving the burst corresponding to a first selected service, wherein said burst is stored with a time table signaling a set of duration values from the start of the first selected burst to the start of its following successive bursts corresponding to a plurality of services. Details for receiving the burst and the pre-stored time table have already been described above.

The receiver also comprises a power controller 802 for powering on and powering off the receiver according to predefined criteria. As discussed above, the receiver is switched on for receiving the burst corresponding to a selected service and is switched off after receiving the intended burst corresponding to the selected service for power saving. And also, the power controller controls the receiver to be switched on or to be switched off according to the pre defined criteria when the receiver receives a switch request.

The receiver also comprises a comparing unit 803 for comparing the time at which a service switch request is received with the start time of the burst of intended switching service. For example, the user is watching service A, at time tq, the user gives a request for switching to service K. The comparing unit is adapted to compare time tq and a first start time Sk1 of burst k1 corresponding to the intended switching service K. As discussed above, the first start time Sk1 is derived from the time table stored in the burst corresponding to the first selected service.

According to the result of the comparison carried out by the comparing unit 803, two situations may happen.

First situation: if the request time tq is earlier than the first start time Sk1, then the receiver is switched on by said power controller according to the first start time Sk1;

Second situation: if the request time tq is later than the first start time Sk1, then the receiver needs to obtain a second start time Sk2 of burst k2, which follows burst k1 corresponding to the second selected service K (the intended switching service), and then the receiver is switched on by said power controller according to the second start time Sk2.

Detailed description has already been given in the above method at steps 105, 106 and 107 for these two conditions. Therefore, no more explanations will be given.

This invention also proposes a transmitter (not shown) for transmitting a signal corresponding to a service selected from a plurality of services, said signal being transmitted in the time slicing mode in the form of a plurality of bursts. The transmitter comprises a time table generator for generating a time table, said time table signaling a set of duration values from the start of a given burst to the start of its following successive bursts corresponding to said plurality of services, and a storing unit for storing a time table in each burst to be transmitted from said plurality of bursts. A time table generator can be software or hardware or firmware. The way of storing the time table in a burst has already been presented above. Hence, no more details will be given here.

There are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions. Nor does it exclude that an assembly of items of hardware or software or both carry out a function.

The remarks made hereinbefore demonstrate that the detailed description with reference to the drawings, illustrate rather than limit the invention. There are numerous alternatives, which fall within the scope of the appended claims. Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. A method of receiving by a receiver a signal corresponding to a service selected from a plurality of services, said signal being transmitted in the time slicing mode in the form of a plurality of bursts, the method comprising the steps of:
receiving (101) a first burst (a1) corresponding to a first selected service (A), wherein a first time table (tt1) is stored in said first burst (a1) for signaling a set of duration values from the start of said first burst (a1) to the start of its following successive bursts corresponding to said plurality of services;
powering off (102) said receiver after receiving said first burst (a1);
comparing (104) a first start time (Sk1) of a second burst (k1) corresponding to a second selected service (K) with a request (103) time (tq) when a request to switch from said first selected service (A) to said second selected service (K) is received by said receiver, said first start time (Sk1) being derived from said first time table (tt1);
if said request time (tq) is earlier than said first start time (Sk1), powering on said receiver according to said first start time (Sk1);
if said request time (tq) is later than said first start time (Sk1), obtaining (106) a second start time (Sk2) of a third burst (k2) corresponding to said second selected service (K), said third burst (k2) following said second burst (k1), and then powering on (107) said receiver according to said second start time (Sk2).

2. A method as claimed in claim 1, wherein said following successive bursts are within one burst cycle, the step of obtaining (106) a second start time (Sk2) further comprising the steps of:
powering on (401) said receiver for receiving a currently transmitted burst (m1) corresponding to one of said plurality of services after performing said comparing step, said second start time (Sk2) being derived from a second time table (tt2) stored in said currently transmitted burst (m1);
powering off (402) said receiver until receiving said third burst (k2) according to said second start time (Sk2).

3. A method as claimed in claim 1, wherein said following successive bursts include two burst cycles, said obtaining (106) step obtains said second start time (Sk2) from said first time table (tt1).

4. A method of transmitting by a transmitter a signal corresponding to a service selected from a plurality of services, said signal being transmitted in the time slicing mode in the form of a plurality of bursts, the method comprising the steps of:
storing a time table in each given burst to be transmitted among said plurality of bursts, said time table including a set of duration values from the start of said given burst to the start of its following successive bursts corresponding to said plurality of services and a set of packet identifiers (PID) linking said following successive bursts to said set of duration values.

5. A method as claimed in claim 4, wherein in said storing step said time table is stored in a padding area of the application data table of said given burst.

6. A method as claimed in claim 4, wherein said storing step stores said time table in a descriptor of PSI/SI information, said PSI/SI information being signaled periodically.

7. A method as claimed in claims 4, wherein said storing step stores said set of duration values of said time table by replacing an original delta-t value separately in successive MPE section headers of said given burst, said original delta-t value signals the duration from the start of said given burst to the start of the following burst corresponding to a same service among said plurality of services.

8. A method as claimed in claim 7, wherein said storing step stores said set of packet identifiers (PID) of the time table in the reserved bits of successive FEC section headers within said given bursts.

9. A method as claimed in claim 7, wherein said storing step stores said set of packet identifiers in a descriptor of PSI/SI information, said PSI/SI information being signaled periodically.

10. A method as claimed in claim 4, said given burst and its following successive bursts forming one burst cycle.

11. A method as claimed in claim 4, said given burst and its following successive bursts forming two continuous burst cycles.

12. A receiver receiving a signal corresponding to a service selected from a plurality of services, said signal being transmitted in the time slicing mode in the form of a plurality of bursts, the receiver comprising:
a receiving unit for receiving a first burst (a1) corresponding to a first selected service (A), wherein said first burst (a1) is stored with a first time table (tt1) signaling a set of duration values from the start of said first burst (a1) to the start of its following successive bursts corresponding to said plurality of services;
a power controller for powering-on said receiver after receiving said first burst (a1);
a comparing unit for comparing a first start time (Sk1) of a second burst (k1) corresponding to a second selected service (K) with a request time (tq) when a switch request from said first selected service (A) to said second selected service (K) is received by said receiver, said first start time (Sk1) being derived from said first time table (tt1);
if said request time (tq) is earlier than said first start time (Sk1), powering on said receiver by said power controller according to said first start time (Sk1);
if said request time (tq) is later than said first start time (Sk1), obtaining a second start time (Sk2) of a third burst (k2) corresponding to said second selected service (K), said third burst (k2) following said second burst (k1), and then powering on said receiver by said power controller according to said second start time (Sk2).

13. A transmitter for transmitting a signal corresponding to a service selected from a plurality of services, said signal being transmitted in the time slicing mode in the form of a plurality of bursts, said transmitter comprising:
a time table generator for generating a time table, said time table signaling a set of duration values from the start of a given burst to the start of its following successive bursts corresponding to said plurality of services.
a storing unit for storing a time table in each given burst to be transmitted among said plurality of bursts.
